(19) United States
(12) Patent Application Publication
(10) Pub. No.: US 2019/0320669 A1
(43) Pub. Date: Oct. 24, 2019

(54) SMOKER WITH SMOKE ON DEMAND SYSTEM

(71) Applicant: Masterbuilt Manufacturing, LLC, Columbus, GA (US)

(72) Inventors: Olin Powell, Columbus, GA (US); Daniel Mercer, Hamilton, GA (US)

(21) Appl. No.: 16/389,385

(22) Filed: Apr. 19, 2019

Related U.S. Application Data
(60) Provisional application No. 62/660,585, filed on Apr. 20, 2018.

(51) Int. Cl. A23B 4/052; A47J 37/06

(52) U.S. Cl. CPC A23B 4/0523; A23V 2002/00; A47J 37/0629

(57) ABSTRACT

A smoker with a smoke on demand system includes a wood chunk or wood chip enclosure with a wood heating element, a wood temperature sensor, and a controller. In response to the sensed wood temperature, the controller causes the wood heating element to maintain the wood chunks or wood chips within a target temperature range above which the wood chunks or wood chips can sustain combustion without added heat. The actual temperature can also be maintained by timed sequences based on the cold mass and species of the wood.

### CLAIM OF PRIORITY

This application claims priority from U.S. Provisional Patent Application Ser. No. 62/660,585, filed on Apr. 20, 2018, which is incorporated herein in its entirety.

### FIELD OF THE INVENTION

This invention relates to a smoker/grill for slowly cooking food while imparting a smoked flavor to the food and more particularly to a smoker/grill with a smoke on demand system for controlling the quality of the smoke produced from fuel including wood chunks and wood chips.

### BACKGROUND OF THE INVENTION

Traditional smokers use a primary heat source, generally an electric heating element, to cook the food and to heat the wood chunks or wood chips to a point of combustion which causes the chucks or chips to smolder and produce smoke. On a hot day, however, the smoker will maintain temperatures such that the electric heating element will not switch on with enough frequency or duration to effectively heat the chunks or chips to the point where the chunks or chips produce smoke.

An improvement to the single heating element, and currently in the market today, is the addition of a second wood heating element to heat the wood chunks or wood chips independently from the primary heat source. This solves the problem of having to use the primary heat source to heat the wood chunks or wood chips. Once the combustion process of the wood chunks or wood chips begins, however, the wood chunks or wood chips will generally continue to smoke till the wood chunks or wood chips become ash. Such a system lacks the ability to switch the wood smoke on and off at will and to regulate the quality of the smoke produced.

Therefore, a need exists to control the temperature of the wood chunks or wood chips while they are producing smoke. Smoke that is released from wood chunks or wood chips that have just reached the smoldering point is of a different quality than wood chunks or wood chips heated past their sustained combustion point. The smoke resulting from wood chunks or wood chips being heated past their sustained combustion point is white and bitter. For most wood species, conventional research identifies the wood burning process as follows.

Stage 1—Dehydration (up to 500 F). In this stage wood must be heated from a separate heat source. The wood dries out, water steams and evaporates, and some gases like carbon dioxide are given off, but there is no flame or heat produced.

Stage 2—Pyrolysis (390 F-700 F). In this stage the wood begins to produce phenols, oily liquids, and tars. Combustion point is around 575 F

Stage 3—Smoking Sweet Spot (650-750 F). Highest concentration of phenols, oil, and tar droplets.

Stage 4—Charcoal Formation (above 1000 F). Most organic compounds have burned off

Further, different wood species have different temperatures defining at which point the wood reaches the above various stages.

### SUMMARY OF THE INVENTION

In order to produce a thin sweet smoke that is typically defined as “Thin Blue Smoke” in the industry, the wood chunks or wood chips should be maintained at a temperature just below the temperature at which the wood chunks or wood chips will sustain combustion without outside heat input. Sustained combustion depends on the cold mass or volume of the wood chunks or wood chips being used for smoking. The larger the cold mass of the wood chunks or wood chips, the higher the temperature to which the wood can be heated before the wood will sustain combustion without outside heat input. Further, limiting the amount of oxygen available to the wood chunks or wood chips lowers the sustained combustion temperature. By maintaining the heat of the wood chunks or wood chips just below the sustain combustion temperature in a low oxygen environment will produce the desired sweet thin blue smoke. The smoker of the present invention produces the optimum thin blue smoke by regulating the amount of heat supplied to the wood chunks or wood chips by a wood heating element. The smoker of the present invention will work with all types of wood including wood chunks and wood chips.

In one embodiment of the smoker of the present invention, the smoker controls the temperature of the wood chunks or wood chips just below the sustain combustion temperature by placing a temperature sensor at the location of the wood chunks or wood chips being heated. A controller receives the temperature input from the temperature sensor and modulates the wood heating element to achieve a desired smoke level and quality. The smoke level and quality can be set using pre-defined smoke settings for various wood chunks or wood chips or by monitoring directly the wood smoking temperature. Customization is built into the controller to allow the user to learn which setting or temperature gives the best smoking results for the flavor (species) of wood used.

By sensing the temperature of the wood and thereby modulating the wood heating element, the wood heating element gives just enough heat to raise and maintain the wood temperature between 300° F. and 500° F. and thereby slowly release the wood oils and phenols. By maintaining the wood temperature between 300° F. and 500° F., most wood species deliver a sweet thin blue smoke.

In a second embodiment, the temperature of the wood is controlled by an on and off timing sequence of the wood heating element. For example, the controller can have a number of settings, each setting having a different on and off timing sequence. Each setting corresponds to a particular wood species and uses an on and off timing sequence to assure optimum smoke generation from the particular wood species.

In the second embodiment of the smoker the present invention, a temperature sensor functions as a limit switch to limit the temperature of the wood to 125° F. above the cabinet temperature. In operation, the controller shuts off the wood heating element once the wood temperature, monitored by the temperature sensor, exceeds the cabinet temperature by 125° F. Once the wood temperature drops to 35° F. above the cabinet temperature, the controller continues the on and off timing sequence for the wood heating element in accordance with the selected timing sequence.

Further objects, features and advantages will become apparent upon consideration of the following detailed description of the invention when taken in conjunction with the drawings and the appended claims.

### BRIEF DESCRIPTION OF THE DRAWINGS

FIG. 1 is a front perspective view of a smoker in accordance with the present invention.

FIG. 2 is a front elevation of the smoker in accordance with the present invention.

FIG. 3 is a front elevation view of the smoker in accordance with the present invention with the door removed to reveal internal detail.

FIG. 4 is an enlarged front elevation view of the smoker in accordance with the present invention with the door removed to reveal internal detail.

FIG. 5 is an enlarged front elevation view of the smoker in accordance with the present invention with the door and the cover of the wood chunk or wood chip enclosure removed to reveal internal detail.

FIG. 6 is an enlarged perspective view of the smoker in accordance with the present invention with the door and the cover of the wood chunk or wood chip enclosure removed to reveal internal detail.

FIG. 7 is an enlarged section perspective view of the smoker in accordance with the present invention with the door and the cover of the wood chunk or wood chip enclosure removed to reveal internal detail.

FIG. 8 is a block diagram of controller for the smoker in accordance with the present invention.

FIG. 9 is a graphical representation of five illustrative smoking sequences for the smoker in accordance with the present invention.

FIG. 10 is a series of photographs illustrating the condition of the wood chunks that produce the smoke identified as none, low, medium, heavy, and real heavy.

### DETAILED DESCRIPTION OF THE PREFERRED EMBODIMENT

In order to produce a sweet thin blue smoke, the wood chunks or wood chips should be maintained at a target temperature or in a range below the target temperature. For temperatures just above the target temperature, the wood chunks or wood chips will sustain combustion without added heat thereby producing smoke with undesirable flavor attributes. For temperatures within the range below and including a target temperature, the wood chunks and wood chips will produce the desired sweet thin blue smoke.

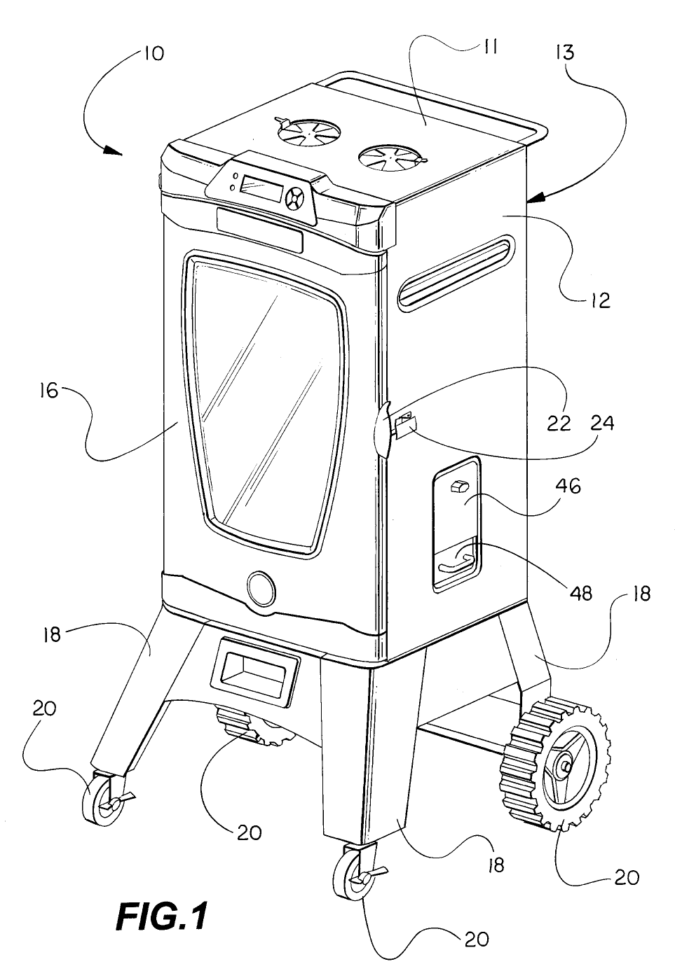

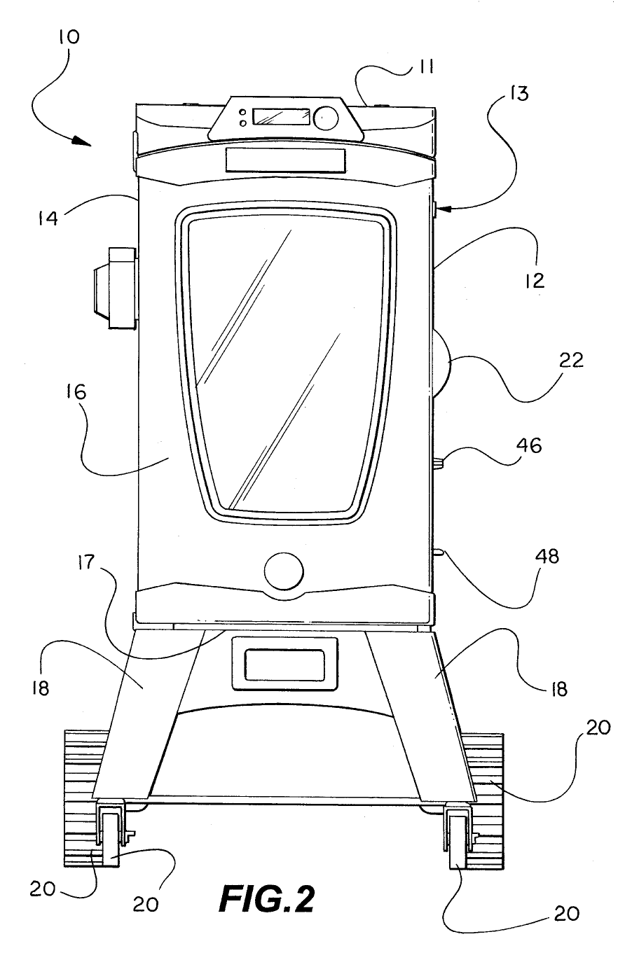

Turning to FIG. 1-7, the smoker 10 of the present invention includes a cabinet 13 supported on legs 18 and wheels 20. The cabinet 13 includes a top 11, a right side 12, a left side 14, a back 15, and a bottom 17. A hinged front door 16 has a handle 22 and is secured in a closed position by a latch 24.

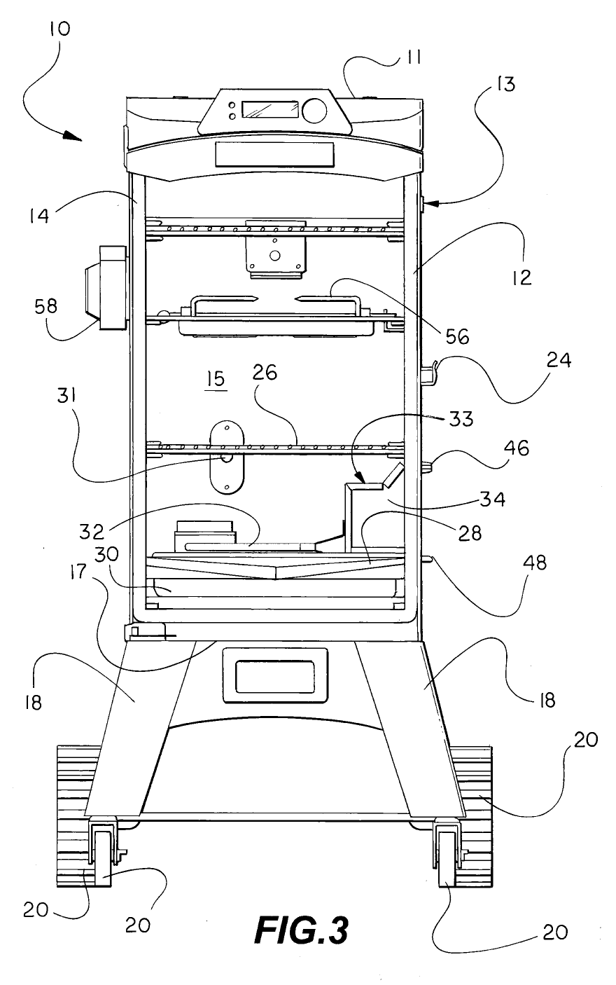

With reference to FIG. 3, the door 16 of the cabinet 13 is removed revealing one or more grill racks, such as grill rack 26, mounted inside the cabinet 13 to support the food product to be cooked and smoked. A rotisserie 56 powered by a rotisserie motor 58 may also be mounted inside the cabinet 13. A primary electric heating element 32 is positioned near the bottom 17 of the cabinet 13. A cabinet temperature sensor 31 is attached to the inside surface of the back 15 and senses the temperature inside the cabinet 13. A grease deflector 28 is positioned below the primary electric heating element 32 and directs drippings from the food products supported on the grill racks 26 into greased pan 30. The cabinet 13 may also include a liquid pan (not shown). Liquid in a liquid pan evaporates in the presence of heat in the cabinet 13 and provides moisture for the food product and additional flavoring.

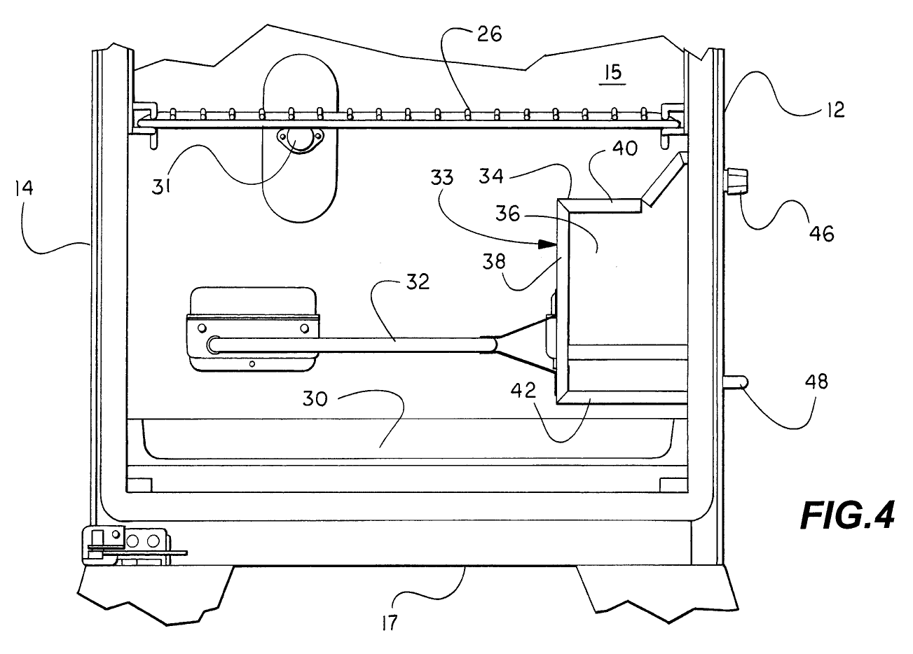

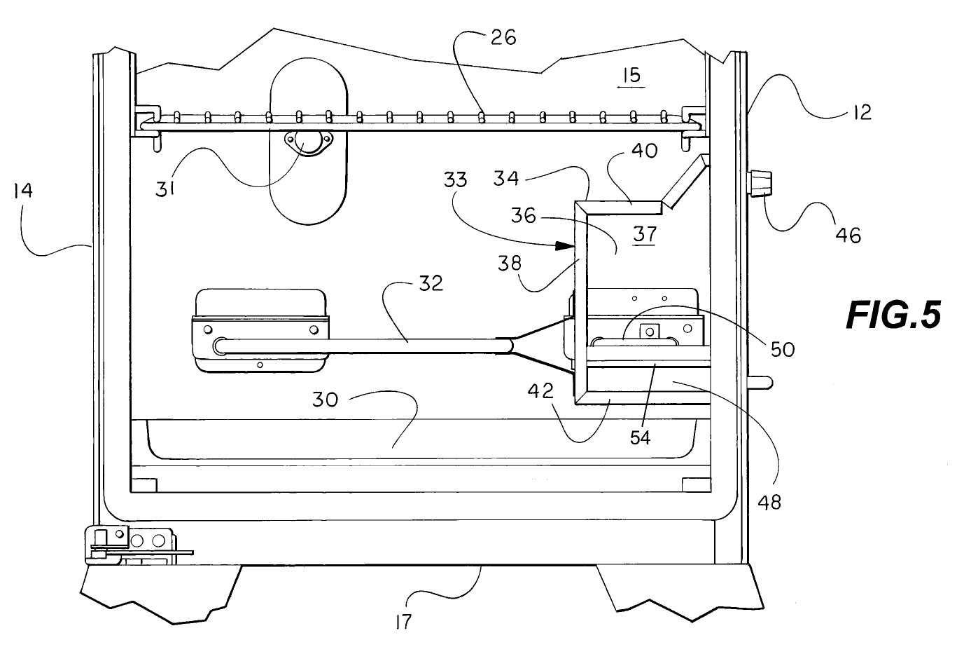

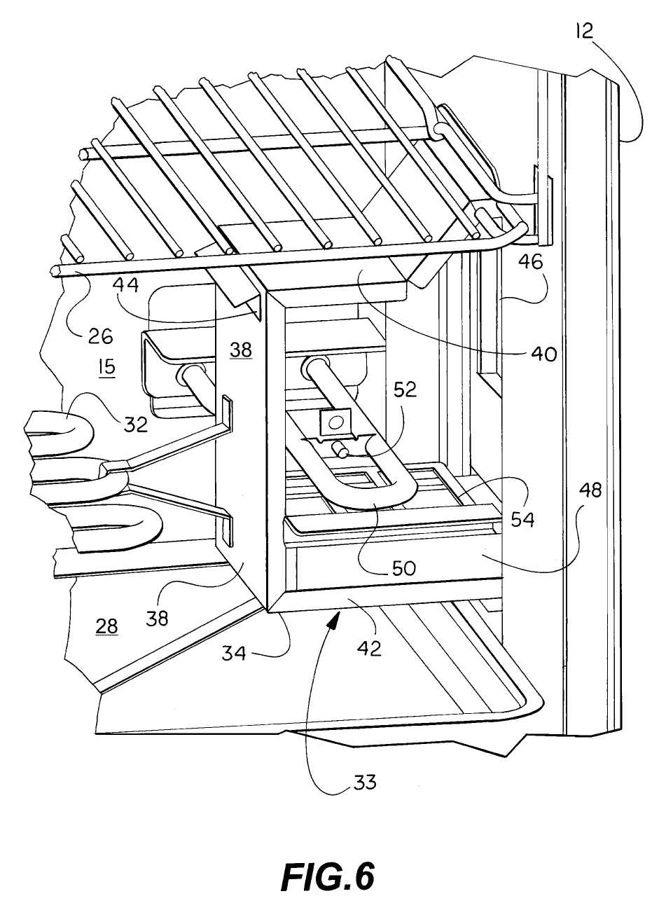

In order to provide smoke for the smoker 10, the smoker 10 has a smoke on demand system 33 (FIGS. 3-6). The smoke on demand system 33 includes a wood chunk or wood chip enclosure 34 mounted to the internal surface of the right side 12 beneath the lower grill rack 26. The wood chunk or wood chip enclosure 34 includes a front cover 36 (FIG. 4), a back cover 37 (FIG. 5), an end 38, a top 40, and a bottom 42. The end 38 has a smoke outlet 44 (FIG. 6) that allows smoke created inside of the enclosure 34 to flow into the internal space within the cabinet 13.

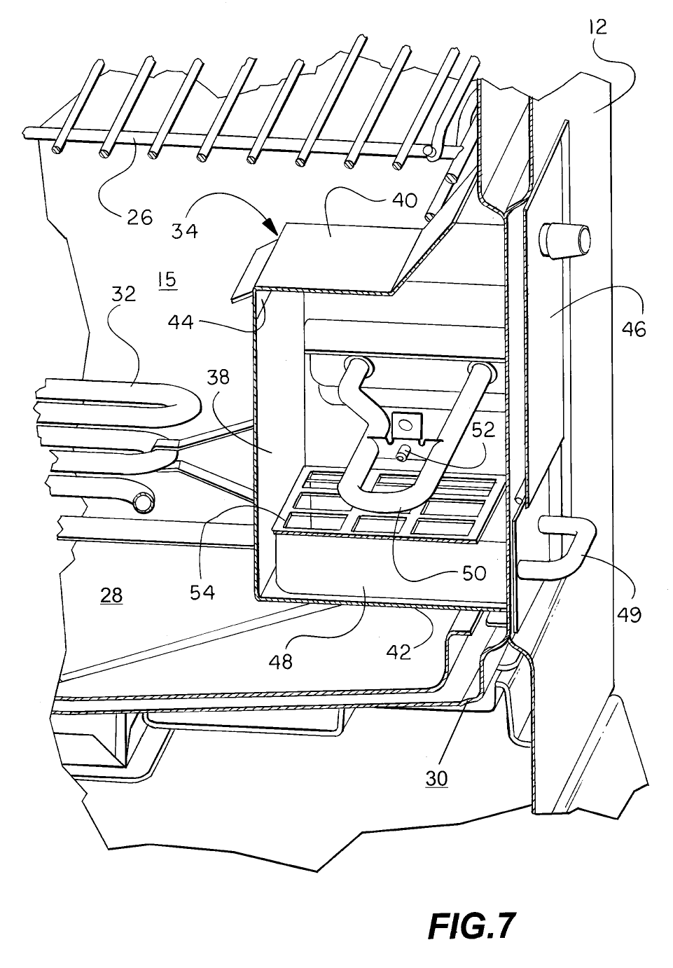

The wood enclosure 34 also includes a wood support grate 54 (FIGS. 6 and 7) for supporting the wood chunks or wood chips with an ash pan 48 positioned below the support grate 54. An ash pan handle 49 (FIG. 7) is connected to the ash pan 48 to facilitate sliding the ash pan 48 out of the enclosure 34 in order to empty accumulated ash. An access door 46 (FIG. 7) in the side 12 of the cabinet 13 allows the user to fill the enclosure 34 with wood chunks or wood chips. An electric wood heating element 50 (FIGS. 6 and 7) is positioned within the enclosure 34 and above the wood support grate 54. A wood temperature sensor 52 extends into the space above the wood support grate 54 occupied by the wood chunks or wood chips in order to measure the temperature of the wood chunks or wood chips. Because the wood chunk or wood chip enclosure 34 is enclosed, combustion air is limited to the air that enters through the smoke outlet 44 and around the ash pan 48 and the access door 46. By limiting the combustion air, the target temperature for the wood chunks or wood chips supported by the grate 54 is lower than the target temperature for the wood chunks or wood chips in the presence of unrestricted or forced combustion air.

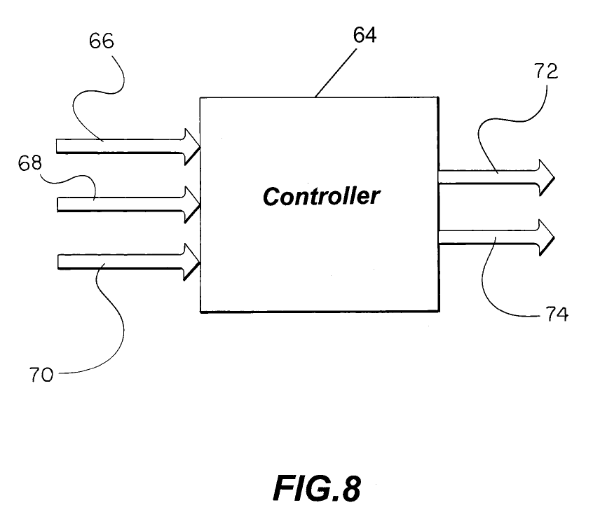

The smoker 10 also includes a controller 64 (FIG. 8) that controls the operation of the primary heating element 32 and the wood heating element 50. Controlling the operation of the primary heating element 32 and the wood heating element 50 depends on a user setting signal 70, a cabinet temperature signal 66 from the cabinet temperature sensor 31, and a wood temperature signal 68 from the wood temperature sensor 52. Based on the inputs to the controller 64, the controller 64 produces a primary heating element signal 72 to control the operation of the primary heating element 32 and a wood heating element signal 74 to control the operation of the wood heating element 50.

In operation, the food products to be cooked and smoke are placed on the grill racks 26. The primary heating element 32 is energized to heat the internal volume of the cabinet 13 to cook the food product. In order to smoke the food product, wood chunks or wood chips are introduced into the enclosure 34 by means of access door 46. The wood chunks or wood chips are supported on the wood support grate 54. The wood heating element 50 is energized to heat the wood chunks or wood chips to a target range of temperatures below and including the target temperature. The target temperature is the temperature above which the wood chunks or wood chips sustain combustion without added heat. When the wood chunks and wood chips are maintained in the target temperature range for the particular wood chunks or wood chips, the wood chunks or wood chips will produce a sweet thin blue smoke.

As indicated, the target temperature range, including the target temperature, depends in part on the cold mass or volume of the wood chunks or wood chips being used for smoking. The larger the cold mass or volume of the wood chunks or wood chips, the higher the target temperature to which the wood can be heated before the wood will sustain combustion without outside heat input. The smoker of the present invention produces the optimum sweet thin blue smoke by regulating the amount of heat supplied to the wood by a wood heating element 50. The smoker of the present invention will work with all types of wood including wood chunks and wood chips.

Further, limiting the amount of oxygen available to the wood chunks or wood chips will lower the target temperature range thereby requiring less heat required to produce the sweet thin blue smoke. As previously indicated, the available combustion air results from the size of the enclosure 34, size of the smoke outlet 44, and the openings around the access door 46 and the ash pan 48. Alternatively, the enclosure 34 could be tightly sealed and a controllable damper installed to more accurately control the amount of air available in the wood enclosure 34 for producing smoke.

In a first embodiment of the smoker 10 of the present invention, the smoker 10 controls the target temperature range of the wood chunks or wood chips by placing a wood temperature sensor 52 at the location of the wood chunks or wood chips being heated. The controller 64 receives the wood temperature signal from the wood temperature sensor 52 and modulates the wood heating element 50 to achieve the desired target temperature range and therefore the desired smoke quality. Alternatively, the controller 64 can be preprogrammed for wood species and cold mass and thereby determined the target temperature range. Once the wood heating element 50 has been energized, the wood temperature sensor 52 senses the temperature of the wood and sends a wood temperature signal 68 to the controller 64. The controller 64 then modulates wood heating element so that 50 the wood heating element 50 supplies just enough heat to raise and maintain the wood temperature within the target temperature range, including the target temperature, and thereby slowly release the wood oils and phenols. The user setting signal 70 allows the user to learn which setting or temperature range gives the best smoking results for the species of wood used.

In a second embodiment, the temperature of the wood chunks or wood chips is controlled by an on and off timing sequence of the wood heating element 50. For example, the controller 64 can have a number of settings, each setting having a different on and off timing. Each setting corresponds to a particular wood species and uses an on and off timing sequence to assure optimum smoke generation from the particular wood species and cold mass. As an example, a smoker 10 of the present invention can have five settings set forth below:

S1:
Element “ON” 2 min
Element “OFF” 10 min

S2:
Element “ON” 4 min
Element “OFF” 5 min

S3:
Element “ON” 4.5 min
Element “OFF” 4.5 min

S4:
Element “ON” 5.5 min
Element “OFF” 5 min

S5:
Element “ON” 6.5 min
Element “OFF” 6 min

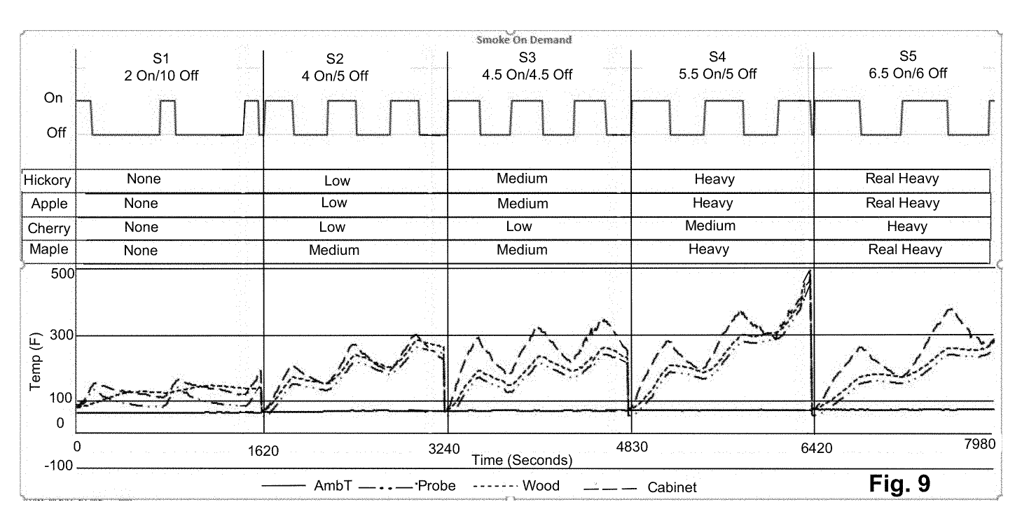

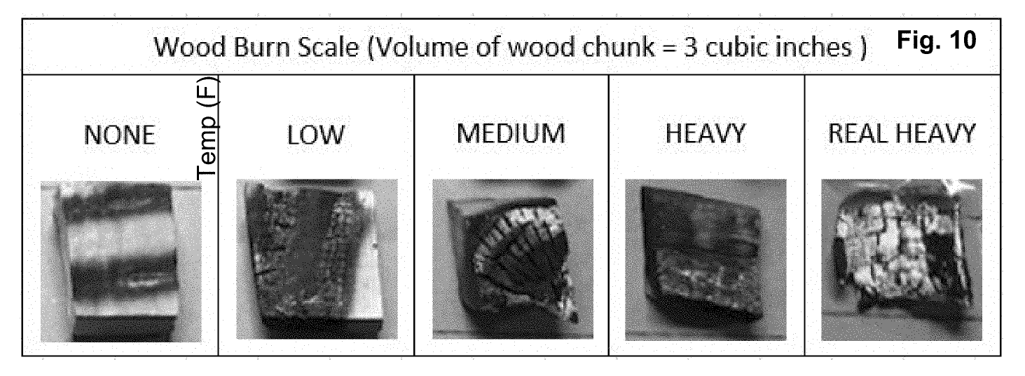

The timing sequences (S1-S5) and results are illustrated in FIG. 9. FIG. 9 illustrates the temperature response and the smoke produced for each of the sequences (S1-S5) over a time 0-7980 seconds. The cabinet temperature plot results from the temperature sensor 31 in the cabinet and the probe temperature results from the temperature sensor 52 in the wood enclosure 34. The wood probe temperature results from an additional temperature sensor installed directly in the wood pile for the purposes of more directly measuring the temperature of the wood and for the purpose of creating the graphical representation of FIG. 9. The ambient temperature was maintained essentially constant as shown by the flat solid line in FIG. 9. Finally, FIG. 9 characterizes the smoke produced based on the illustrations in FIG. 10.

In the second embodiment of the smoker 10 of the present invention, the wood temperature sensor 52 in combination with the controller 64 functions as a limit switch to limit the temperature of the wood chunks or wood chips to 125° F. above the cabinet temperature as determined by the cabinet temperature sensor 31. In operation, the controller 64 shuts off the wood heating element 50 once the wood temperature, monitored by the wood temperature sensor 52, exceeds the cabinet temperature by 125° F. Once the wood temperature drops to 35° F. above the cabinet temperature, the controller 64 continues the on and off timing sequence of the wood heating element 50 in accordance with the selected user setting.

While this invention has been described with reference to preferred embodiments thereof, it is to be understood that variations and modifications can be affected within the spirit and scope of the invention as described herein and as described in the appended claims.

I claim:

1. A smoker for cooking and smoking a food product comprising:
a. an enclosed cabinet with:
i. an access door;
ii. at least one rack vertically located within the cabinet for holding the food product to be cooked;
b. a primary heating element for cooking the food product; and
c. a smoke on demand system associated with the cabinet for controlling the quality of smoke from wood chunks or wood chips including:
i. a wood chunk or wood chip enclosure having:
(a) a wood support grate;
(b) an ash pan below the grate;
(c) an access door for loading wood chunks or wood chips into the enclosure and onto the grate;
(d) a smoke outlet in the enclosure for allowing smoke from the wood chunks or wood chips to circulate into the cabinet;
(e) a wood heating element in the enclosure; and
(f) temperature sensor adjacent the grate for determining a wood temperature of the wood chunks or wood chips and producing a temperature output signal; and
ii. a controller for receiving the temperature output signal and modulating energy delivered to the wood heating element in order to maintain the wood chunks or wood chips within a target temperature range above which the wood chunks or wood chips can sustain combustion without added heat.

2. The smoker of claim 1, wherein the wood chunks or wood chips have a cold mass, and based on the cold mass, the controller determines the target temperature range and based on the temperature output signal, the controller modulates the energy delivered to the wood heating element in order to maintain wood chunks of wood chips within the target temperature range.

3. The smoker of claim 2, wherein the wood chunks or wood chips are a wood species and based on the wood species and the cold mass, the controller determines the target temperature range and based on the temperature output signal, the controller modulates the energy delivered to the wood heating element in order to maintain the wood chunks or the wood chips in the target temperature range.

4. The smoker of claim 1, wherein the enclosure has an air inlet with a damper for controlling air to the enclosure and wherein the controller controls the damper and the volume of air entering the enclosure in order to adjust the target temperature range.

5. A method for controlling quality of smoke from wood chunks or wood chips in a smoker, the steps comprising:
a. depositing wood chunks or wood chips into an enclosure associated with the smoker;
b. heating wood chunks or wood chips within the enclosure by means of a wood heating element;
c. sensing a wood temperature of the wood chunks or wood chips within the enclosure and generating a wood temperature signal;
d. determining a target temperature range above which the wood chunks or wood chips can sustain combustion without added heat; and
e. in response to the wood temperature signal, modulating energy supplied to the wood heating element to maintain the wood chunks or wood chips at the target temperature range above which the wood chunks or wood chips can sustain combustion without added heat.

6. The method of claim 5, wherein the target temperature range is determined based on the cold mass of the wood chunks or wood chips.

7. The method of claim 5, wherein the target temperature range is determined based on the wood species of the wood chunks or wood chips.

8. The method of claim 5, wherein the target temperature range is determined based on the amount of air available for combustion available in the enclosure.

9. A smoker for cooking and smoking a food product comprising:
a. an enclosed cabinet with:
i. an access door;
ii. at least one rack vertically located within the cabinet for holding the food product to be cooked;
b. a primary heating element for cooking the food product; and
c. a smoke on demand system inside the cabinet for controlling quality of smoke from wood chunks or wood chips including:
i. a wood chunk or wood chip enclosure having:
(a) a wood support grate;
(b) an ash pan below the grate;
(c) an access door for loading wood chunks or wood chips into the enclosure and onto the grate;
(d) a smoke outlet in the enclosure for allowing smoke from the wood chunks or wood chips to circulate into the cabinet; and
(e) a wood heating element in the enclosure; and
ii. a controller for turning the wood heating element on and off in a timed sequence in order to maintain the wood chunks or wood chips within a target temperature range above which the wood chunks or wood chips can sustain combustion without added heat.

10. The smoker of claim 9, wherein the wood chunks or wood chips have a cold mass, and based on the cold mass, the controller determines the target temperature range.

11. The smoker of claim 9, wherein the wood chunks or wood chips are a wood species and based on the wood species, the controller determines the target temperature range.

12. The smoker of claim 9, wherein the enclosure has an air inlet with a damper for controlling air to the enclosure and wherein the controller controls the damper and the volume of air entering the enclosure in order to adjust the target temperature range.

13. The smoker of claim 9, wherein the smoke on demand system includes a wood temperature sensor adjacent the grate for determining the wood temperature of the wood chunks or wood chips and for producing an wood temperature signal, and wherein the smoke on demand system further includes a cabinet temperature sensor for determining a cabinet temperature inside the cabinet and for producing a cabinet temperature signal, and based on the wood temperature signal, the controller turns off the wood heating element when the wood temperature exceeds the cabinet temperature by a predetermined amount.

14. A method for controlling quality of smoke from wood chunks or wood chips in a smoker, the steps comprising:
a. depositing the wood chunks or wood chips into an enclosure associated with the smoker;
b. heating the wood chunks or wood chips within the enclosure by means of a wood heating element;
c. determining a target temperature range above which the wood chunks or wood chips can sustain combustion without added heat; and
d. turning the wood heating element on and off in a timed sequence in order to maintain the wood chunks or wood chips at the target temperature range.

15. The method of claim 14, wherein the target temperature range is determined based on the cold mass of the wood chunks or wood chips.

16. The method of claim 14, wherein the target temperature range is determined based on the wood species of the wood chunks or wood chips.

17. The method of claim 14, wherein the target temperature range is determined based on the amount of air available for combustion in the enclosure.

18. The method of claim 14, wherein the method includes determining the wood temperature of the wood chunks or wood chips in the enclosure, determining a cabinet temperature inside the cabinet, and based on the wood temperature turning off the wood heating element when the wood temperature exceeds the cabinet temperature by a predetermined amount.
